(19) United States
(12) Patent Application Publication
(10) Pub. No.: US 2013/0008867 A1
(43) Pub. Date: Jan. 10, 2013

(54) METHODS FOR MANUFACTURING MAGNETIC TUNNEL JUNCTION STRUCTURE

(76) Inventors: Ken Tokashiki, Seongnam-si (KR); Hyung-Joon Kwon, Seongnam-si (KR); Myeong-Cheol Kim, Suwon-si (KR)

(21) Appl. No.: 13/533,385

(22) Filed: Jun. 26, 2012

(30) Foreign Application Priority Data
Jul. 7, 2011 (KR) 10-2011-0067426

(51) Int. Cl. H01F 41/00

(52) U.S. Cl. 216/22

(57) ABSTRACT

Methods for manufacturing a magnetic tunnel junction structure include forming a magnetic tunnel junction (MTJ) layer by sequentially stacking a first ferromagnetic layer, a tunnel insulation layer, and a second ferromagnetic layer on a substrate, forming a mask pattern on the MTJ layer, and etching at least a portion of the MTJ layer in an etching chamber using the mask pattern as an etch mask, wherein the etching of the at least a portion of the MTJ layer includes applying a RF source power to a first electrode of the etching chamber as first RF power in a first pulselike mode, and applying a RF bias power to a second electrode of the etching chamber as second RF power in a second pulselike mode. The second pulselike mode of the RF bias power has a different phase from the first pulselike mode of the RF source power.

### CROSS-REFERENCE TO RELATED APPLICATION

This application claims priority from Korean Patent Application No. 10-2011-0067426 filed on Jul. 7, 2011 in the Korean Intellectual Property Office, and all the benefits accruing therefrom under 35 U.S.C. §119(e), the contents of which are herein incorporated by reference in their entirety.

### BACKGROUND

1. Field

Example embodiments relate to methods for manufacturing a magnetic tunnel junction structure.

2. Description of the Related Art

A magnetic random access memory (MRAM) device is capable of writing and reading data at high speed and capable of maintaining data even after power supply is interrupted, which is a characteristic of a nonvolatile memory device. Owing to such features, the MRAM has recently been drawing attention as a new memory device.

In general, a unit cell of the MRAM is an element for storing data and typically employs a magnetic tunnel junction (MTJ) pattern. The MTJ pattern includes two ferromagnetic layers: a pinned ferromagnetic layer having a magnetization direction that is fixed, and a free magnetic layer having a magnetization direction that is freely varied either to be parallel or anti-parallel, and a tunnel insulation layer sandwiched between the pinned ferromagnetic layer and the free ferromagnetic layer.

If the ferromagnetic layers are physically (e.g., using a liquid) etched to form the MTJ pattern, conductive products are generated and adhered to sidewalls of the MTJ pattern. However, a short may occur in the MTJ pattern due to the conductive products resulting from the physical etching.

### SUMMARY

Example embodiments relate to methods for manufacturing a magnetic tunnel junction structure. Example embodiments provide methods for manufacturing a magnetic tunnel junction structure, which can prevent a short in the magnetic tunnel junction structure while improving resistance characteristics.

Example embodiments also provide a magnetic random access memory (MRAM) device, which can prevent a short of the magnetic tunnel junction structure while improving resistance characteristics.

These and other example embodiments will be described in or be apparent from the following description of the preferred embodiments.

According to example embodiments, there is provided a method for forming a magnetic tunnel junction structure, the method including forming a magnetic tunnel junction (MTJ) layer by sequentially stacking a first ferromagnetic layer, a tunnel insulation layer, and a second ferromagnetic layer on a substrate, forming a mask pattern on the MTJ layer, and etching at least a portion of the MTJ layer in an etching chamber using the mask pattern as an etch mask. The etching of the at least a portion of the MTJ layer includes applying a RF source power to a first electrode of the etching chamber as a first RF power in a first pulselike mode, and applying a RF bias power to a second electrode of the etching chamber as a second RF power in a second pulselike mode, wherein the second pulselike mode of the RF bias power has a different phase from the first pulselike mode of the RF source power.

The applying of the RF source power and the applying of the RF bias power may include applying the RF source power and the RF bias power such that a phase difference between the first pulselike mode of the RF source power and the second pulselike mode of the RF bias power is in a range of between 90° and 180°.

The etching of the at least one portion of the MTJ layer may further include injecting a first etch gas into the etching chamber. The injecting of the first etch gas may include supplying one selected from a gas forming a carbonyl compound and a gas forming a sulfur compound. The supplying of the gas forming the carbonyl compound may include supplying a gas including at least one of CO, CO₂, COS, and COF₂ as the first etch gas. The supplying of the gas forming the sulfur compound may include supplying a gas including at least one of COS and CS₂ as the first etch gas.

The etching of the at least one portion of the MTJ layer may further include injecting a first etch gas into the etching chamber, and a gas including at least one of CO, CO2, COS, CS₂, COF₂, and PF₃ are supplied as the first etch gas.

The applying of the RF source power may include applying the first RF power with a frequency of 2 MHz or greater, and the applying of the RF bias power may include applying the second RF power with a frequency of 1 MHz or less.

The first etch gas may form negative ions in the etching chamber.

The first ferromagnetic layer and the second ferromagnetic layer may include at least one of platinum (Pt), palladium (Pd), cobalt (Co), manganese (Mg), iron (Fe), iridium (Ir) and combinations thereof.

The etching of the at least one portion of the MTJ layer may include etching the at least one portion of the MTJ layer using etching equipment based on one selected from an inductively coupled plasma (ICP), a capacitively coupled plasma (CCP), electron cyclotron resonance (ECR), reactive ion etching (RIE), magnetically enhanced RIE (MERIE), and a helicon wave.

According to example embodiments, there is provided a method for forming a magnetic tunnel junction structure, the method including forming a magnetic tunnel junction (MTJ) layer by sequentially stacking a ferromagnetic layer, a tunnel insulation layer, and a second ferromagnetic layer on a substrate, forming a mask pattern on the MTJ layer, and etching at least a portion of the MTJ layer in an etching chamber using the mask pattern as an etch mask. A RF source power is applied to a first electrode of the etching chamber as a first RF power in a first pulselike mode, and a RF bias power is applied to a second electrode of the etching chamber as a second RF power in a second pulselike mode. The second RF power of the RF bias power has a frequency of 1 MHz or less.

The applying of the RF source power and the applying of the RF bias power may include applying the RF source power and the RF bias power such that a phase difference between the first pulselike mode of the RF source power and the second pulselike mode of the RF bias power is in a range of between 90° and 180°.

The etching of the at least one portion of the MTJ layer may further include injecting a first etch gas into the etching chamber. The injecting of the first etch gas may include supplying one selected from a gas forming a carbonyl compound and a gas forming a sulfur compound.

The etching of the at least one portion of the MTJ layer may further include injecting a first etch gas into the etching chamber, and the injecting of the first etch gas may include supplying a gas including at least one of CO, CO2, COS, CS₂, COF₂, PF₃, and combinations thereof.

The etching of the at least one portion of the MTJ layer may further include injecting a first etch gas into the etching chamber. The first etch gas may form negative ions in the etching chamber.

The etching of the at least one portion of the MTJ layer may include etching the at least one portion of the MTJ layer using etching equipment based on one selected from an inductively coupled plasma (ICP), a capacitively coupled plasma (CCP), electron cyclotron resonance (ECR), reactive ion etching (RIE), magnetically enhanced RIE (MERIE), and a helicon wave.

According to example embodiments, there is provided a method for manufacturing a magnetic tunnel junction structure, including forming a magnetic tunnel junction (MTJ) layer by sequentially stacking a first ferromagnetic layer, a tunnel insulation layer, and a second ferromagnetic layer on a substrate, forming a mask pattern on the MTJ layer, and removing a portion of the MTJ layer to form the magnetic tunnel junction structure by subjecting the MTJ layer to ions generated from a first RF power and a second RF power having a mode out of phase with that of the first RF power.

A phase difference between the mode of the first RF power and a mode of the second RF power may be in a range of between 90° and 180°.

Removing the portion of the MTJ layer may include positioning the MTJ layer formed on the substrate in an etching chamber, and intermittently applying a RF source power to a first electrode of the etching chamber as the first RF power and a RF bias power to a second electrode of the etching chamber as the second RF power to generate the ions.

Intermittently applying the RF bias power to the second electrode may include applying the RF bias power to a plasmatized gas to generate negative ions. The second RF power of the RF bias power may have a frequency of 1 MHz or less.

### BRIEF DESCRIPTION OF THE DRAWINGS

Example embodiments will be more clearly understood from the following detailed description taken in conjunction with the accompanying drawings. FIGS. 1-19 represent non-limiting, example embodiments as described herein.

FIG. 1 is a cross-sectional view of a magnetic tunnel junction structure according to example embodiments;

FIG. 2 is a cross-sectional view of a magnetic random access memory (MRAM) device according to example embodiments;

FIG. 3 is a flowchart illustrating a method for forming a magnetic tunnel junction structure according to example embodiments;

FIGS. 4 to 6 are cross-sectional views of intermediate structures illustrating a method for forming a magnetic tunnel junction structure according to example embodiments;

FIG. 7 illustrates an etching device used in a method for forming a magnetic tunnel junction structure according to example embodiments;

FIG. 8 illustrates a phase difference between RF source power and RF bias power of 90° in etching equipment used in a method for forming a magnetic tunnel junction structure according to example embodiments;

FIG. 9 illustrates a phase difference between RF source power and RF bias power of 180° in etching equipment used in a method for forming a magnetic tunnel junction structure according to example embodiments;

FIG. 10 illustrates a phase difference between RF source power and RF bias power is in a range of 90° to 180° in etching equipment used in a method for forming a magnetic tunnel junction structure according to example embodiments;

FIG. 11 is a graph illustrating a distribution of ionized particles used in a method for forming a magnetic tunnel junction structure according to example embodiments;

FIG. 12 illustrates movement of etched particles in a method for forming a magnetic tunnel junction structure according to example embodiments;

FIG. 13 is a cross-sectional view illustrating a method for forming a magnetic tunnel junction structure according to other example embodiments;

FIG. 14 illustrates a state of incidence of etched particles in the method for forming a magnetic tunnel junction structure shown in FIG. 13;

FIGS. 15 and 16 are cross-sectional views of intermediate structures illustrating a method for forming a magnetic random access memory (MRAM) device according to example embodiments; and

FIGS. 17 to 19 illustrates of application examples of MRAMs according to example embodiments.

### DETAILED DESCRIPTION OF EXAMPLE EMBODIMENTS

Various example embodiments will now be described more fully with reference to the accompanying drawings in which some example embodiments are shown. However, specific structural and functional details disclosed herein are merely representative for purposes of describing example embodiments. Thus, the invention may be embodied in many alternate forms and should not be construed as limited to only example embodiments set forth herein. Therefore, it should be understood that there is no intent to limit example embodiments to the particular forms disclosed, but on the contrary, example embodiments are to cover all modifications, equivalents, and alternatives falling within the scope of the invention.

In the drawings, the thicknesses of layers and regions may be exaggerated for clarity, and like numbers refer to like elements throughout the description of the figures.

Although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that, if an element is referred to as being “connected” or “coupled” to another element, it can be directly connected, or coupled, to the other element or intervening elements may be present. In contrast, if an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” if used herein, specify the presence of stated features, integers, steps, operations, elements and/or components, but do not preclude the presence or addition of one or more other features, integers, steps, operations, elements, components and/or groups thereof.

Spatially relative terms (e.g., “beneath,” “below,” “lower,” “above,” “upper” and the like) may be used herein for ease of description to describe one element or a relationship between a feature and another element or feature as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, for example, the term “below” can encompass both an orientation that is above, as well as, below. The device may be otherwise oriented (rotated 90 degrees or viewed or referenced at other orientations) and the spatially relative descriptors used herein should be interpreted accordingly.

Example embodiments are described herein with reference to cross-sectional illustrations that are schematic illustrations of idealized embodiments (and intermediate structures). As such, variations from the shapes of the illustrations as a result, for example, of manufacturing techniques and/or tolerances, may be expected. Thus, example embodiments should not be construed as limited to the particular shapes of regions illustrated herein but may include deviations in shapes that result, for example, from manufacturing. For example, an implanted region illustrated as a rectangle may have rounded or curved features and/or a gradient (e.g., of implant concentration) at its edges rather than an abrupt change from an implanted region to a non-implanted region. Likewise, a buried region formed by implantation may result in some implantation in the region between the buried region and the surface through which the implantation may take place. Thus, the regions illustrated in the figures are schematic in nature and their shapes do not necessarily illustrate the actual shape of a region of a device and do not limit the scope.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In order to more specifically describe example embodiments, various aspects will be described in detail with reference to the attached drawings. However, the present invention is not limited to example embodiments described.

Example embodiments relate to methods for manufacturing a magnetic tunnel junction structure.

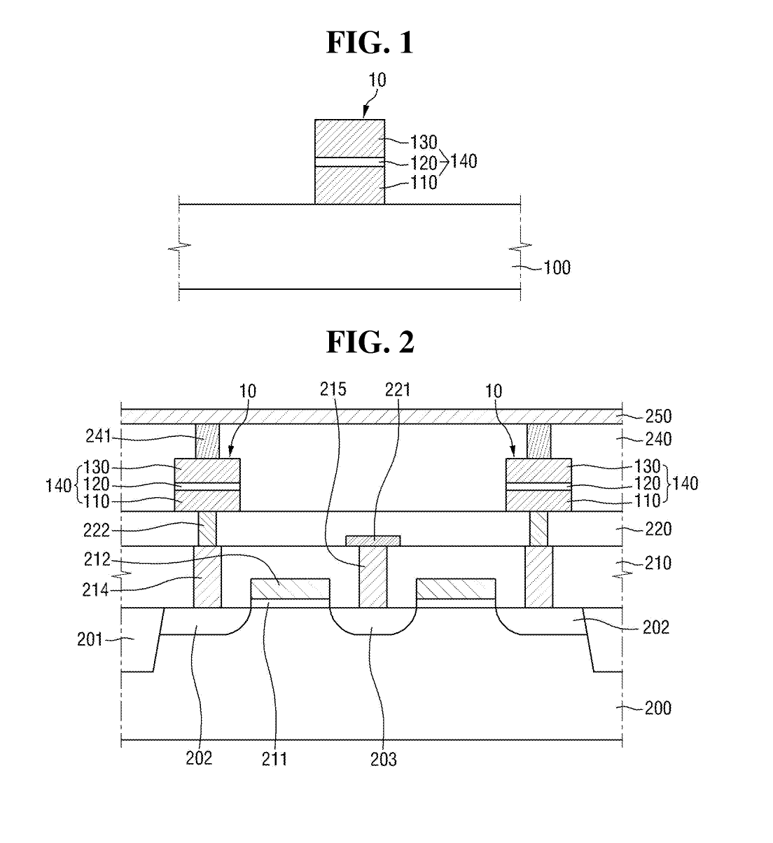

Hereinafter, a magnetic tunnel junction structure according to example embodiments will be described with reference to FIG. 1.

FIG. 1 is a cross-sectional view of a magnetic tunnel junction structure according to example embodiments.

Referring to FIG. 1, the magnetic tunnel junction (MTJ) structure 10 may include an MTJ layer pattern 140 including a first ferromagnetic layer pattern 110, a tunnel insulation layer pattern 120, and a second ferromagnetic layer pattern 130 sequentially stacked on a substrate 100.

Any one of the first ferromagnetic layer pattern 110 and the second ferromagnetic layer pattern 130 may be a pinned ferromagnetic layer pattern having a magnetization direction that is fixed, and the other may be a free magnetic layer pattern having a magnetization direction that is varied according to the direction of current applied to the MTJ layer pattern 140. The first ferromagnetic layer pattern 110 and the second ferromagnetic layer pattern 130 may be, for example, a single layer or a stacked (or multi-) layer made of a ferromagnetic material including at least one selected from the group consisting of palladium (Pd), cobalt (Co), platinum (Pt), ruthenium (Ru), tantalum (Ta), nickel (Ni), iron (Fe), boron (B), manganese (Mn), antimony (Sb), aluminum (Al), chromium (Cr), molybdenum (Mo), silicon (Si), copper (Cu), iridium (Ir) and combinations thereof. For example, the first ferromagnetic layer pattern 110 and the second ferromagnetic layer pattern 130 may be formed using cobalt iron (CoFe), nickel iron (NiFe), cobalt iron boron (CoFeB) or combinations thereof.

The tunnel insulation layer pattern 120 may be formed between the first ferromagnetic layer 110 and the second ferromagnetic layer 130. The tunnel insulation layer pattern 120 is an insulated tunnel barrier that causes quantum mechanical tunneling between the first ferromagnetic layer 110 and the second ferromagnetic layer 130. The tunnel insulation layer pattern 120 may be made of magnesium oxide (MgO) or aluminum oxide (Al₂O₃), but not limited thereto.

FIG. 2 is a cross-sectional view of a magnetic random access memory (MRAM) device according to example embodiments.

The MRAM shown in FIG. 2 is a spin transfer torque (STT)-MRAM device. The STT-DRAM device uses a spin torque transfer (STT) phenomenon, which if a magnetization direction of a magnetic body is not identical with the spin direction of current when a high density current with an aligned spin direction is applied to the magnetic body, the magnetic body tends to be aligned in the spin direction of current. Because a digit line is not used in the STT-MRAM device, miniaturization can be achieved. However, the STT-MRAM device shown in FIG. 2 is provided only for illustration, and the MRAM device including the MTJ structure according to example embodiments can be applied to various structures.

Referring to FIG. 2, an access element may be disposed on a select region of a substrate 200. The substrate 200 may be a silicon (Si) substrate, a gallium arsenic (GaAs) substrate, a silicon germanium (SiGe) substrate, a ceramic substrate, a quartz substrate or a glass substrate for display, or a semiconductor on insulator (SOI) substrate. The access element may be a metal oxide semiconductor (MOS) transistor. In this case, the access element may be disposed on an active region defined by an isolation layer 201 formed on the select region of the substrate 200. In detail, the access element is disposed in the active region and includes a source region 203 and a drain region 202 separated from each other. In addition, the access element may include a gate electrode 212 formed on a channel region between the source region 203 and the drain region 202. The gate electrode 212 extends across the active region and serves as a word line. The gate electrode 212 is insulated from the active region by a gate insulation layer 211.

A first interlayer dielectric film 210 is formed on the substrate 200 having the access element, and a source line 221 may be disposed on (or over) a select region of the first interlayer dielectric film 210 corresponding to the source region 203. The source line 221 may extend in the same direction as the gate electrode 212. While FIG. 2 illustrates that the source region 203 is shared by adjacent access elements, example embodiments are not limited thereto. For example, source and drain regions may not be shared by adjacent access elements.

A source line contact plug 215 electrically connecting the source line 221 and the source region 203, and a landing contact plug 214 formed on (or over) the drain region 202, may be formed in the first interlayer dielectric film 210.

A second interlayer dielectric film 220 is formed on the first interlayer dielectric film 210 having the source line 221. A bottom electrode contact plug 222 electrically connected to the landing contact plug 214 formed on (or over) the drain region 202 may be formed in the second interlayer dielectric film 220.

A magnetic tunnel junction structure 10 including the MTJ layer pattern 140 is disposed on the second interlayer dielectric film 220. The MTJ layer pattern 140 includes the first ferromagnetic layer pattern 110, the tunnel insulation layer pattern 120, and the second ferromagnetic layer pattern 130 sequentially stacked on the second interlayer dielectric film 220. The magnetic tunnel junction structure 10 is substantially the same as the magnetic tunnel junction structure 10 shown in FIG. 1, and therefore a detailed description thereof will be omitted for the sake of brevity.

The MTJ layer pattern 140 and the drain region 202 may be electrically connected to each other through the landing contact plug 214 and the bottom electrode contact plug 222.

A third interlayer dielectric film 240 may be formed on the substrate 200 having the magnetic tunnel junction structure 10, and a bit line 250 may be disposed on (or over) the third interlayer dielectric film 240 to cross the gate electrode 212. The bit line 250 and the MTJ layer pattern 140 may be electrically connected to each other through a top electrode contact plug 241.

The first, second and third interlayer dielectric films 210, 220 and 240 may be formed of a silicon oxide layer, or silicon oxynitride layer. The landing contact plug 214, the source line contact plug 215, the source line 221, the bottom electrode contact plug 222, the top electrode contact plug 241, and the bit line 250 may be formed using, for example, tungsten (W), ruthenium (Ru), tantalum (Ta), copper (Cu), aluminum (Al), titanium (Ti), titanium nitride (TiN), doped polysilicon and combinations thereof.

Metal wires electrically connected to peripheral circuits (not shown) may further be formed on the bit line 250.

Hereinafter, a method for forming a magnetic tunnel junction structure according to example embodiments will be described with reference to FIGS. 1 and 3 to 12.

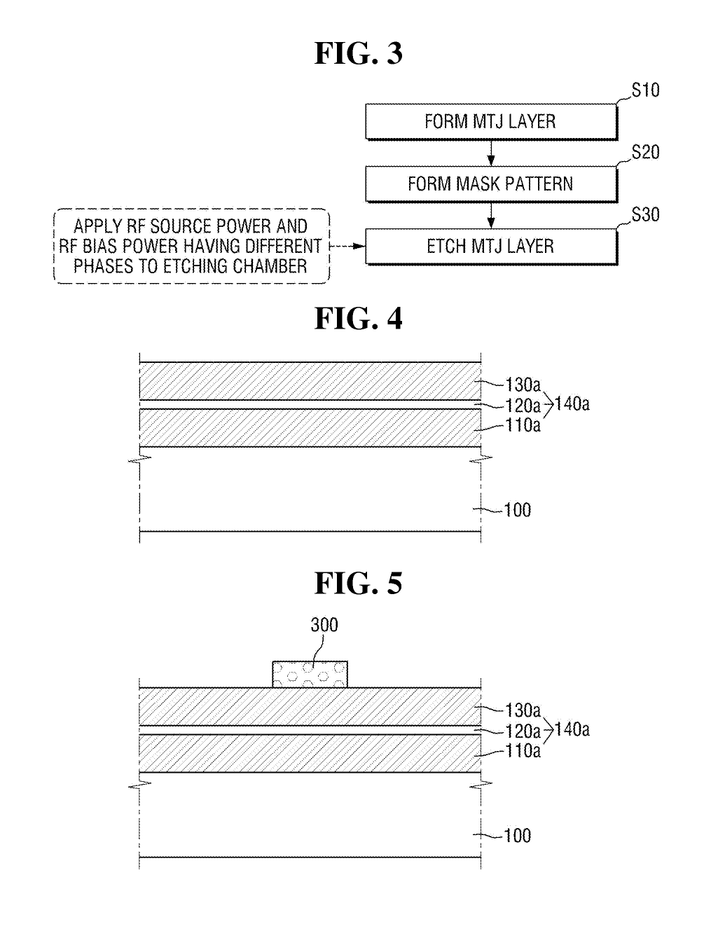

FIG. 3 is a flowchart illustrating a method for forming a magnetic tunnel junction structure according to example embodiments, and FIGS. 4 to 6 are cross-sectional views of intermediate structures illustrating a method for forming a magnetic tunnel junction structure according to example embodiments.

Referring to FIGS. 3 and 4, a first ferromagnetic layer 110, a tunnel insulation layer 120, and a second ferromagnetic layer 130 are sequentially on a substrate 100 to form an MTJ layer 140 (S10).

The first ferromagnetic layer 110 and the second ferromagnetic layer 130 may be, for example, a single layer or a stacked layer made of a ferromagnetic material including at least one selected from the group consisting of Pd, Co, Pt, Ru, Ta, Ni, Fe, B, Mn, Fe, Sb, Al, Cr, Mo, Si, Cu, Ir and combinations thereof. For example, the first ferromagnetic layer pattern 110 and the second ferromagnetic layer pattern 130 may be formed using cobalt iron (CoFe), nickel iron (NiFe), or cobalt iron boron (CoFeB). The tunnel insulation layer 120 may be made of magnesium oxide (MgO) or aluminum oxide (Al₂O₃), but not limited thereto.

Referring to FIGS. 3 and 5, a mask pattern 300 may be formed on the MTJ layer 140 (S20). The mask pattern 300 may be formed on a select region where an MTJ pattern (140 of FIG. 1) is to be formed.

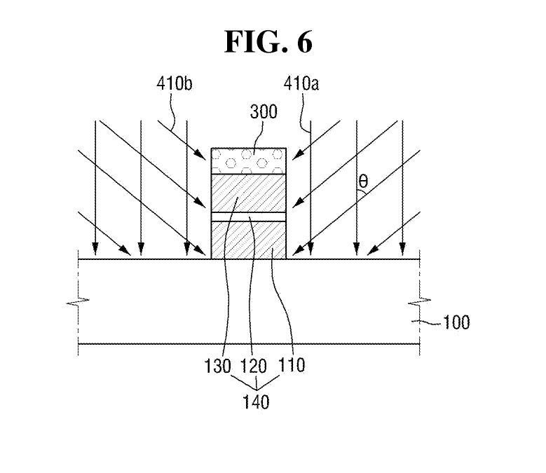

Referring to FIGS. 3 and 6, at least a portion of the MTJ layer 140 may be etched (S30).

More specifically, the at least a portion of the MTJ layer 140 is etched in an etching chamber using the mask pattern 300 as an etching mask. Here, the etching of the at least a portion of the MTJ layer 140 may be performed by applying RF source power to a first electrode of the etching chamber and applying RF bias power to a second electrode of the etching chamber, the RF bias power and the RF source power having different phases from each other.

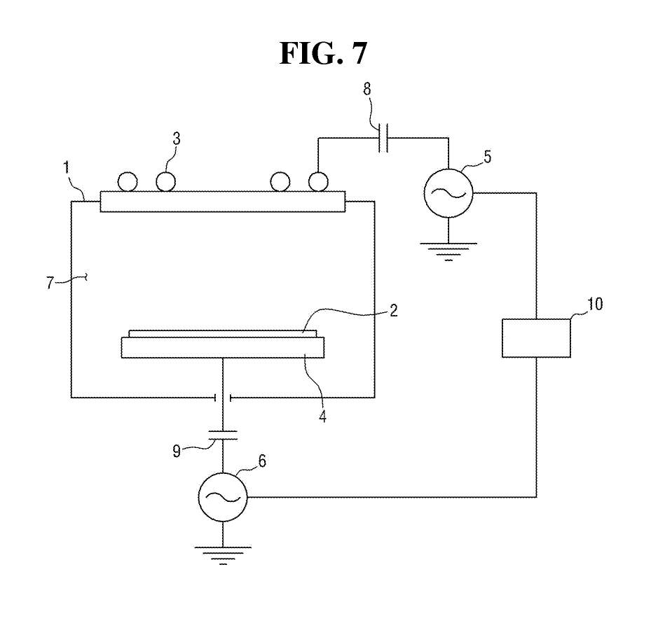

FIG. 7 illustrates an etching device used in a method for forming a magnetic tunnel junction structure according to example embodiments.

Referring to FIG. 7, the MTJ layer 140 may be etched in an etching device 100 having an etching chamber 1. FIG. 7 illustrates a plasma etching equipment (e.g., ICP based etching equipment). The plasma etching equipment may include the etching chamber 1, a substrate 2, a first electrode 3 (e.g., a source electrode), a second electrode 4 (e.g., a bias electrode), an RF source power output unit 5, and an RF bias power output unit 6. While FIG. 7 illustrates ICP based etching equipment, other etching equipment may be used. For example, capacitively coupled plasma (CCP), electron cyclotron resonance (ECR), reactive ion etching (RIE), magnetically enhanced RIE (MERIE), or helicon wave based plasma etching equipment may also be used.

Plasma may be generated in the etching chamber 1 using the source electrode 3 and the bias electrode 4. The source electrode 3 may be formed in the shape of a coil surrounding outer walls of the etching chamber 1 and receives the RF source power output from the RF source power output unit 5. The source electrode 3 primarily contributes to the generation of plasma in the etching chamber 1. The bias electrode 4 receives the RF bias power output from the RF bias power output unit 6. The bias electrode 4 primarily contributes to the adjustment of ion energy incident into the substrate 100. In addition, the bias electrode 4 may function to support the substrate 100.

Here, the RF source power output from the RF source power output unit 5 may mean a first RF power is applied in a first pulselike mode, and the RF bias power output from the RF bias power output unit 6 may mean a second RF power is applied in a second pulselike mode.

A synchronizing unit 10 is connected to the RF source power output unit 5 and the RF bias power output unit 6, and synchronizes the RF source power output from the RF source power output unit 5 and the RF bias power output from the RF bias power output unit 6 with each other.

More specifically, the first RF power may be applied as the RF source power to supply excitation energy for generating plasma. For example, RF power of approximately 2 MHz or higher may be applied as the first RF power, thereby plasma igniting gases supplied into the etching chamber 1. In addition, the second RF power may be applied as the RF bias power to allow ions in the plasma to be incident toward the substrate 100. For example, the RF bias power may be applied to the bias electrode 3 in the second pulselike mode in which the RF power of approximately 1 MHz or less may be applied as the second RF power.

As shown in FIG. 6, ions incident toward the substrate 100 may include ions 410a perpendicularly incident into the substrate 100 and ions 410b incident at an incidence angle (θ), which may be caused by different phases of the second pulselike mode of RF bias power and the first pulselike mode of RF source power. Here, each of the first pulselike mode of RF source power and the second pulselike mode of RF bias power may have a frequency in a range of approximately 100 Hz to approximately 10 kHz, and may have a duty ratio in a range of approximately 10% to approximately 90%.

In other words, the RF source power may be applied to the source electrode 3 in the first pulselike mode in which the RF power of approximately 2 MHz or higher has a frequency in a range of approximately 100 Hz to approximately 10 kHz, and a duty ratio in a range of approximately 10% to approximately 90%. The RF bias power may be applied to the bias electrode 3 in the second pulselike mode in which the RF power of approximately 1 MHz or less has a frequency in a range of approximately 100 Hz to approximately 10 kHz and a duty ratio in a range of approximately 10% to approximately 90%.

In the following description, it will be understood that when the RF bias power and the RF source power are referred to as having different phases, the first pulselike mode of RF source power and the second pulselike mode of RF bias power may have different phases.

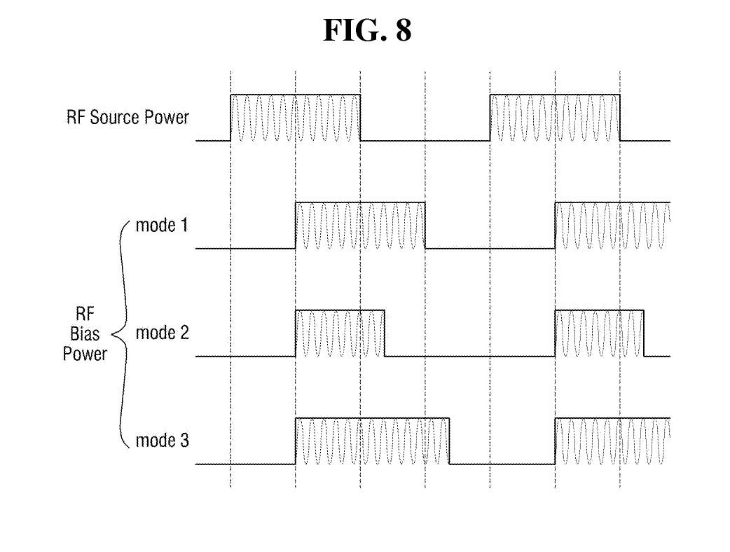

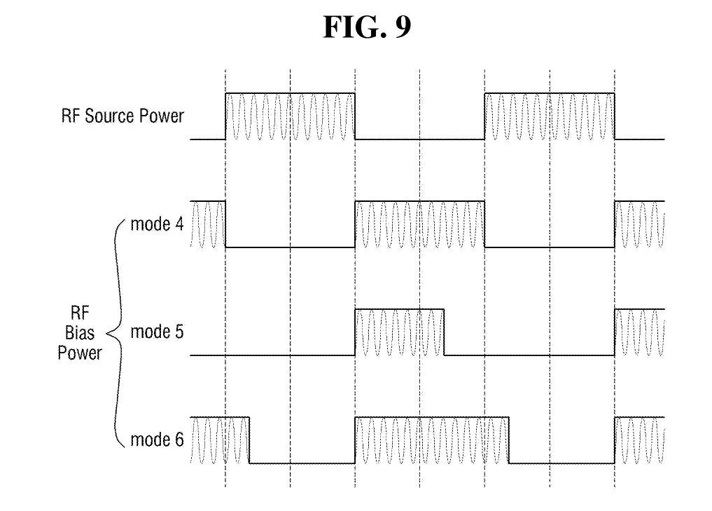

FIGS. 8 to 10 illustrate embodiments of various phase differences between a RF source power and a RF bias power in etching equipment used in a method for forming a magnetic tunnel junction structure according to example embodiments.

In the method for forming a magnetic tunnel junction structure according to example embodiments, the RF source power and the RF bias power may have a phase difference in a range of 90° to 180°.

FIG. 8 illustrates a phase difference between the RF bias power and the RF source power of 90° in etching equipment used in a method for forming a magnetic tunnel junction structure according to example embodiments.

Referring to FIG. 8, in mode 1, a phase difference between the RF bias power and the RF source power is 90°, the RF bias power and the RF source power have the same frequency and duty ratio. In mode 2, a phase difference between the RF bias power and the RF source power is 90°, the RF bias power and the RF source power have the same frequency. However, the RF bias power has a smaller duty ratio than the RF source power. In mode 3, a phase difference between the RF bias power and the RF source power is 90°, the RF bias power and the RF source power have the same frequency. However, the RF bias power has a greater duty ratio than the RF source power.

FIG. 9 illustrates that a phase difference between the RF bias power and the RF source power is 180° in etching equipment used in a method for forming a magnetic tunnel junction structure according to example embodiments.

As described above with reference to FIG. 8, mode 4 of RF bias power represents a case in which a phase difference between RF bias power and RF source power is 180°, the RF bias power and the RF source power have the same frequency, and the RF bias power and the RF source power have the same duty ratio. Mode 5 of RF bias power represents a case in which a phase difference between RF bias power and RF source power is 180°, the RF bias power and the RF source power have the same frequency, and RF bias power has a smaller duty ratio than the RF source power. Mode 4 of RF bias power represents a case in which a phase difference between RF bias power and RF source power is 180°, the RF bias power and the RF source power have the same frequency, and RF bias power has a greater duty ratio than the RF source power.

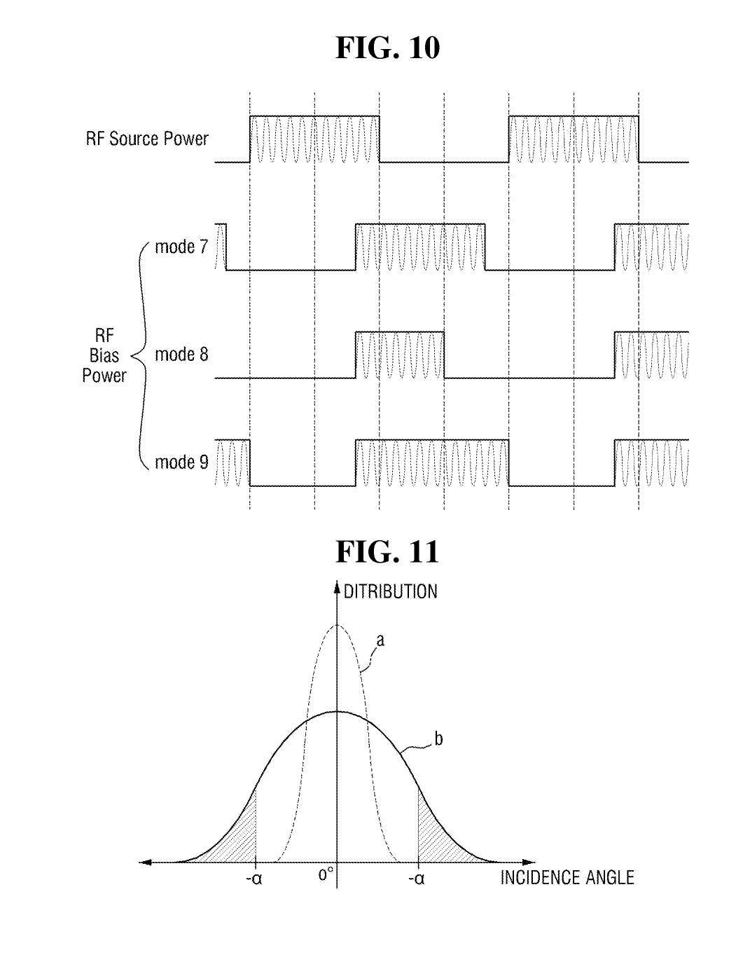

FIG. 10 illustrates that a phase difference between the RF bias power and the RF source power is in a range of 90° to 180° in etching equipment used in a method for forming a magnetic tunnel junction structure according to example embodiments.

As described above, mode 7 of RF bias power represents a case in which a phase difference between RF bias power and RF source power is in a range of 90° to 180°, the RF bias power and the RF source power have the same frequency, and the RF bias power and the RF source power have the same duty ratio. Mode 8 of RF bias power represents a case in which a phase difference between RF bias power and RF source power is in a range of 90° to 180°, the RF bias power and the RF source power have the same frequency, and the RF bias power has a smaller duty ratio than RF source power. Mode 9 of RF bias power represents a case in which a phase difference between RF bias power and RF source power is in a range of 90° to 180°, the RF bias power and the RF source power have the same frequency, and the RF bias power has a greater duty ratio than the RF source power.

As described above, in a case where RF power having a different phase from the RF source power (e.g., RF power having a phase difference in a range of 90° to 180° is applied as a RF bias power), a distribution in the incidence angle of ions incident towards a substrate may be wider than a case where RF power having no phase difference is applied.

FIG. 11 is a graph illustrating a distribution of ionized particles used in a method for forming a magnetic tunnel junction structure according to example embodiments.

As shown in FIG. 11, when RF power and RF source power have the same phase, (i.e., when there is no phase difference between a second pulselike mode of the RF bias power and a first pulselike mode of the RF source power), ions incident towards a substrate may have an incidence angle distribution, as indicated by the curve ‘a’. Unlike the curve ‘a’, when RF bias power and RF source power have different phases (i.e., when there is a phase difference between a second pulselike mode of the RF bias power and a first pulselike mode of the RF source power), ions incident towards a substrate may have an incidence angle distribution, as indicated by the curve ‘b’. When the curve ‘a’ and the curve ‘b’ are compared with each other, the curve ‘a’ indicates that most of ions are incident towards the substrate at a select incidence angle of α or less, while the curve ‘b’ indicates that some of ions (in shaded regions) are incident towards the substrate at a select incidence angle of α or greater.

In other words, the incidence angle distribution of ions incident towards the substrate can be adjusted by adjusting the phase difference between the RF bias power and the RF source power. Here, the incidence angle distribution may be determined in consideration of characteristics of a material forming the MTJ layer to be etched, a width of a target MTJ pattern, and so on.

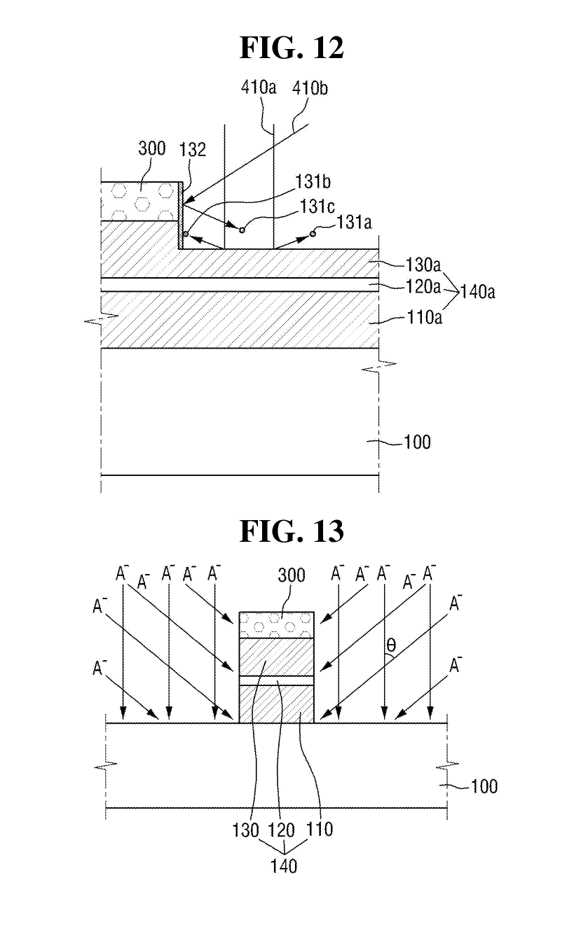

FIG. 12 illustrates movement of etched particles in a method for forming a magnetic tunnel junction structure according to example embodiments.

As shown in FIG. 12, ions incident towards the substrate may include ions 410a perpendicularly incident into the substrate 100 at an incidence angle of 0°, and ions 410b incident into the substrate 100 at a select incidence angle (θ). As described above, the incidence angle θ may be adjusted according to the characteristics of an etching target.

The ions 410a and 410b incident towards the substrate 100 collide with the topmost (or upper) layer of the MTJ layer 140a to be etched, for example, a top surface of a second ferromagnetic layer 130a. Accordingly, the second ferromagnetic layer 130a is etched, some 131a of ferromagnetic materials 131a, 131b and 131c separated from the second ferromagnetic layer 130a are separated from the second ferromagnetic layer 130a to then be removed, and some 131b are redeposited on sidewalls of the MTJ pattern to form a redeposition layer 132. Here, the ions 410b incident in a select incidence angle (θ) may collide with the redeposition layer 132 to prevent the redeposition layer 132 from being generated. That is to say, the redeposition layer 132 may be removed by the ions 410b incident in the select incidence angle (θ). Accordingly, it is possible to prevent a short circuit of the MTJ structure while improving resistance characteristics.

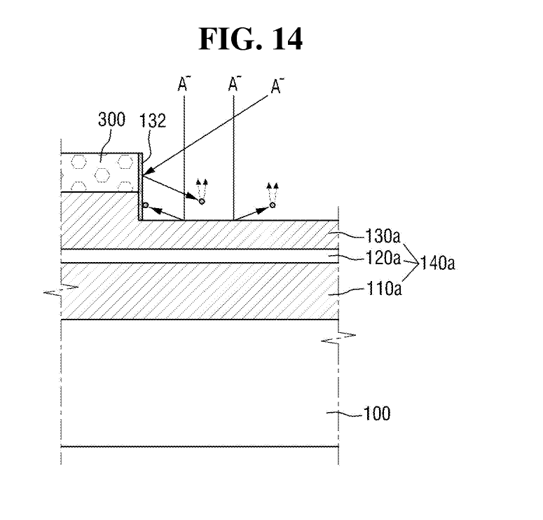

Hereinafter, a method for forming a magnetic tunnel junction structure according to other example embodiments will be described with reference to FIGS. 13 and 14.

FIG. 13 is a cross-sectional view illustrating a method for forming a magnetic tunnel junction structure according to example embodiments, and FIG. 14 illustrates a state of incidence of etched particles in the method for forming a magnetic tunnel junction structure shown in FIG. 13.

In the method for forming a MTJ structure according to other example embodiments, RF bias power is applied with a frequency of 1 MHz or less. Substantially the same contents as those of the previous example embodiments will be briefly described, or will not be described for the sake of brevity.

Like in the previous example embodiments, in the method for forming an MTJ structure according to example embodiments, a first ferromagnetic layer 110, a tunnel insulation layer 120 and a second ferromagnetic layer 130 are sequentially stacked on a substrate to form an MTJ layer 140, a mask pattern 300 is formed on the MTJ layer 140, and at least a portion of the MTJ layer 140 is etched in an etching chamber using the mask pattern 300 as an etch mask. Here, RF source power is applied to a first electrode of the etching chamber, and RF bias power is applied to a second electrode. Here, the RF bias power has a frequency of 1 MHz or less.

Like in the previous example embodiments, the RF source power and the RF bias power may be applied to the first and second electrodes of the etching chamber while varying the phase difference between the RF source power and the RF bias power. Here, the phase difference between the RF source power and the RF bias power is in a range of between 90° and 180°. Thus, as shown in FIG. 13, ions incident toward a substrate may include ions incident in a select incidence angle θ.

In the current example embodiments, the ions incident toward a substrate may include negative ions. As described above, in the in the method for forming an MTJ structure according to example embodiments, RF bias power having a frequency of 1 MHz or less is applied to convert a plasmatized gas into negative ions. The negatively charged gas may demonstrate a much improved etching speed compared to a positively charged gas.

Further, a gas forming a carbonyl compound or a gas forming a sulfur compound may be supplied as the plasmatized etch gas. The gas forming a carbonyl compound may include, for example, at least one of CO, CO₂, COS, COF₂ and combinations thereof. The gas forming a sulfur compound may include, for example, at least one of COS, CS₂ and combinations thereof. Alternatively, at least one of CO, CO₂, COS, CS₂, COF₂, PF₃ and combinations thereof may be supplied as an etch gas.

The aforementioned gases are bonded with a metal material to have a boiling point lower than, for example, a corresponding halide. While FeCl₃ has a boiling point of 317° C., Fe(CO)₅ has a boiling point of 103° C. While NiCl₂ has a boiling point of 1001° C., Ni₂(CO)₄ has a boiling point of 42° C. In general, a temperature of the substrate may be adjusted to approximately 150° C. Accordingly, a material bonded with the metal material may be evaporated to be converted into a gas. In other words, as shown in FIG. 14, because the material bonded with the metal material has a low boiling point, it collides with the MTJ layer 140a and then evaporates, thereby converting into a gas. Accordingly, it is possible to suppress or prevent etching residues from being redeposited on an etching surface of the MTJ layer 140a while enhancing the etching speed.

Further, the etch gas may further include at least one of a H₂ gas, a CH-series gas (e.g., a CH₄ gas), an inert gas (e.g., helium (He), neon (Ne), argon (Ar), krypton (Kr), or xenon (Xe)) and combinations thereof. Such a non-reactive gas may prevent a pattern formed on a substrate from being damaged.

The gas forming a carbonyl compound or the gas forming a sulfur compound may be supplied as the etch gas. In addition, at least one of H₂, a CH-series gas and an inert gas may be supplied as the etch gas.

The forming of the plasmatized etch gas and the forming negative ions using the etch gas in the etching chamber by applying RF bias power of 1 MHz or less are substantially the same as those in the method for forming the MTJ structure according to the previous example embodiments.

Hereinafter, a method for manufacturing (or forming) a magnetic random access memory (MRAM) according to example embodiments will be described with reference to FIGS. 2, 15 and 16.

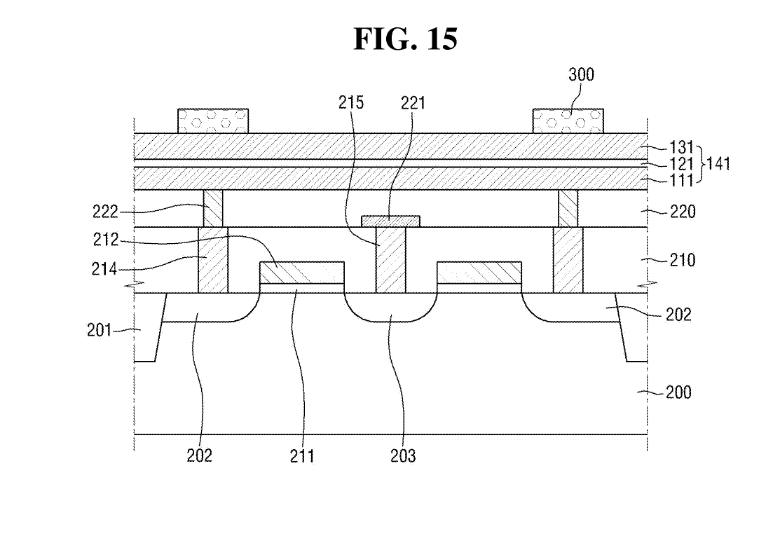

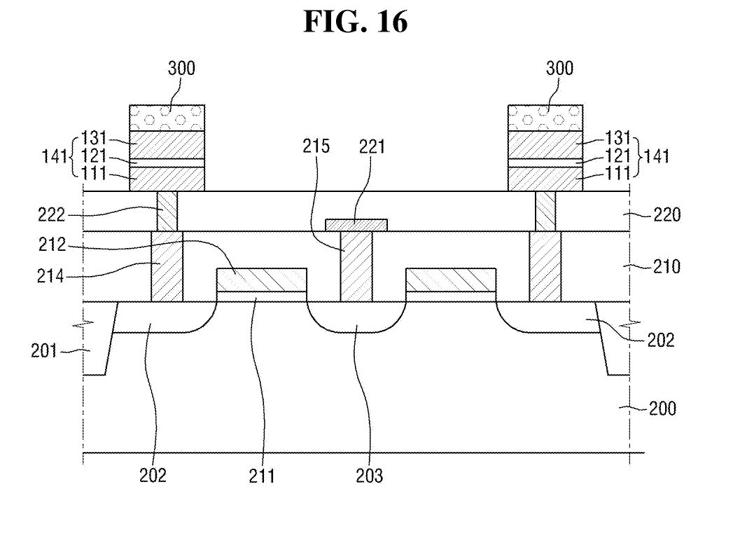

FIGS. 15 and 16 are cross-sectional views of intermediate structures illustrating a method for forming a magnetic random access memory (MRAM) according to example embodiments.

Referring to FIG. 15, an isolation layer 201 defining an active region in a substrate 200 may be formed using a shallow trench isolation (STI) method. A gate insulation layer 211 and a gate electrode 212 may be formed on the active region. A source region 203 and a drain region 202 may be formed by doping impurities into the active region of the substrate 200 exposed by the gate electrode 212.

Next, a first interlayer dielectric film 210 may be formed on the substrate 200 having the gate electrode 212. Contact holes are formed by etching a select region of the first interlayer dielectric film 210 to expose select regions of the drain region 202 and the source region 203, and a landing contact plug 214 and a source line contact plug 215 filling the contact holes may be formed.

Next, a source line 221 electrically connected to the source line contact plug 215 may be formed on the source line contact plug 215. A second interlayer dielectric film 220 may be formed on the entire surface of the substrate 200 having the source line 221.

Next, a contact hole is formed by removing a select region of the second interlayer dielectric film 220 to expose a select region of the landing contact plug 214, and a bottom electrode contact plug 222 filling the contact hole may be formed.

Next, a first ferromagnetic layer 111, a tunnel insulation layer 121, and a second ferromagnetic layer 131 are sequentially stacked on the substrate 200 having the bottom electrode contact plug 222, thereby forming an MTJ layer 141. A mask pattern 300 may be formed on a select region of the second ferromagnetic layer 131.

Referring to FIG. 16, like in FIGS. 6, and 12 to 14, at least a portion of the MTJ layer 141 may be etched using the mask pattern 300 as an etching mask pattern.

Referring to FIG. 2, after removing the mask pattern 300, a third interlayer dielectric film 240 may be formed on the substrate 200 having the MTJ structure 10. Next, a contact hole may be formed by removing a portion of the third interlayer dielectric film 240 to expose a portion of the second ferromagnetic layer pattern 130, and a top electrode contact plug 241 filling the contact hole may be formed. Next, a bit line 250 crossing the gate electrode 121 may be formed on the third interlayer dielectric film 240.

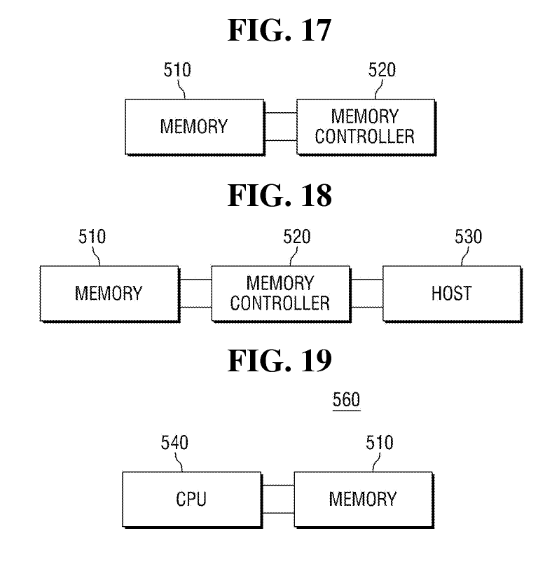

FIGS. 17 to 19 illustrates of application examples of MRAMs according to example embodiments.

Referring to FIG. 17, a system according to example embodiments includes a memory 510 and a memory controller 520 connected to the memory 510. The memory 510 is a nonvolatile memory device using a resistive material manufactured according to example embodiments, and is capable of stably writing and storing multi-bit data. The memory controller 520 supplies an input signal for controlling the operation of the memory 510, such as an address signal and a command signal for controlling read and write operations, to the memory 510.

The system including the memory 510 and the memory controller 520 can be embodied in a card such as a memory card. More specifically, the system according to example embodiments can be implemented as a card that is designed for use in electronic devices and meets an industry standard. Examples of such electronic devices may include mobile phones, two-way communication systems, one way pagers, two-way pagers, personal communication systems, portable computers, Personal Data Assistances (PDAs), audio and/or video players, digital and/or video cameras, navigation systems, and Global Positioning Systems (GPSs). However, example embodiments are not limited thereto, and the system can be embodied in various other forms such as a memory stick.

Referring to FIG. 18, a system according to example embodiments include a memory 510, a memory controller 520 connected to the memory 510 and a host system 530. In this case, the host system 530 is connected to the memory controller 520 via a bus and supplies a control signal to the memory controller 520 that in turn controls the operation of the memory 510. The host system 530 may be a processing system designed for use in mobile phones, two-way communication systems, one way pagers, two-way pagers, personal communication systems, portable computers, personal data assistances (PDAs), audio and/or video players, digital and/or video cameras, navigation systems, and global positioning systems (GPSs).

While FIG. 18 shows that the memory controller 520 is interposed between the memory 510 and the host system 530, the system is not limited thereto. The system may not include the memory controller 520.

Referring to FIG. 19, a system according to example embodiments may be a computer system 560 including a central processing unit (CPU) 540 and a memory 510. In the computer system 560, the memory 510 is connected directly to, or via a bus architecture to, the CPU 540. The memory 510 also stores operation system (OS) instruction sets, basic input/output start up (BIOS) instruction sets, and advanced configuration and power interface (ACPI) instruction sets. The memory 510 can be used as a large-capacity storage device (e.g., a solid state disk (SSD)).

Although FIG. 19 shows only some of the components in the computer system 560 for convenience of explanation, the computer system 560 may have various other configurations. For example, while FIG. 22 shows the computer system 560 does not include the memory controller 520 between the memory 510 and the CPU 540, in other example embodiments, the memory controller 520 may be interposed between the memory 510 and the CPU 540.

The foregoing is illustrative of example embodiments and is not to be construed as limiting thereof. Although a few example embodiments have been described, those skilled in the art will readily appreciate that many modifications are possible in example embodiments without materially departing from the novel teachings and advantages. Accordingly, all such modifications are intended to be included within the scope of this invention as defined in the claims. In the claims, means-plus-function clauses are intended to cover the structures described herein as performing the recited function, and not only structural equivalents but also equivalent structures. Therefore, it is to be understood that the foregoing is illustrative of various example embodiments and is not to be construed as limited to the specific embodiments disclosed, and that modifications to the disclosed embodiments, as well as other embodiments, are intended to be included within the scope of the appended claims.

What is claimed is:

1. A method for manufacturing a magnetic tunnel junction structure, the method comprising:
forming a magnetic tunnel junction (MTJ) layer by sequentially stacking a first ferromagnetic layer, a tunnel insulation layer, and a second ferromagnetic layer on a substrate;
forming a mask pattern on the MTJ layer; and
etching at least a portion of the MTJ layer in an etching chamber using the mask pattern as an etch mask,
wherein the etching of the at least a portion of the MTJ layer includes,
applying a RF source power to a first electrode of the etching chamber as a first RF power in a first pulselike mode; and
applying a RF bias power to a second electrode of the etching chamber as a second RF power in a second pulselike mode, wherein the second pulselike mode of the RF bias power has a different phase from the first pulselike mode of the RF source power.

2. The method of claim 1, wherein the applying of the RF source power and the applying of the RF bias power include applying the RF source power and the RF bias power such that a phase difference between the first pulselike mode of the RF source power and the second pulselike mode of the RF bias power is in a range of between 90° and 180°.

3. The method of claim 1, wherein,
the etching of the at least one portion of the MTJ layer further includes injecting a first etch gas into the etching chamber, and
the injecting of the first etch gas includes supplying one selected from a gas forming a carbonyl compound and a gas forming a sulfur compound.

4. The method of claim 3, wherein the supplying of the gas forming the carbonyl compound includes supplying a gas including at least one of CO, CO₂, COS, and COF₂ as the first etch gas.

5. The method of claim 3, wherein the supplying of the gas forming the sulfur compound includes supplying a gas including at least one of COS and CS₂ as the first etch gas.

6. The method of claim 1, wherein,
the etching of the at least one portion of the MTJ layer further includes injecting a first etch gas into the etching chamber, and
a gas including at least one of CO, CO2, COS, CS₂, COF₂, and PF₃ are supplied as the first etch gas.

7. The method of claim 1, wherein,
the applying of the RF source power includes applying the first RF power with a frequency of 2 MHz or greater, and
the applying of the RF bias power includes applying the second RF power with a frequency of 1 MHz or less.

8. The method of claim 7, wherein the first etch gas forms negative ions in the etching chamber.

9. The method of claim 1, wherein the first ferromagnetic layer and the second ferromagnetic layer include at least one of platinum (Pt), palladium (Pd), cobalt (Co), manganese (Mg), iron (Fe), iridium (Ir) and combinations thereof.

10. The method of claim 1, wherein the etching of the at least one portion of the MTJ layer includes etching the at least one portion of the MTJ layer using etching equipment based on one selected from an inductively coupled plasma (ICP), a capacitively coupled plasma (CCP), electron cyclotron resonance (ECR), reactive ion etching (RIE), magnetically enhanced RIE (MERIE), and a helicon wave.

11. A method for manufacturing a magnetic tunnel junction structure, the method comprising:
forming a magnetic tunnel junction (MTJ) layer by sequentially stacking a ferromagnetic layer, a tunnel insulation layer, and a second ferromagnetic layer on a substrate;
forming a mask pattern on the MTJ layer; and
etching at least a portion of the MTJ layer in an etching chamber using the mask pattern as an etch mask,
wherein the etching of the at least a portion of the MTJ layer includes,
applying a RF source power to a first electrode of the etching chamber as a first RF power in a first pulselike mode, and
applying a RF bias power to a second electrode of the etching chamber as a second RF power in a second pulselike mode, wherein the second RF power of the RF bias power has a frequency of 1 MHz or less.

12. The method of claim 11, wherein the applying of the RF source power and the applying of the RF bias power include applying the RF source power and the RF bias power such that a phase difference between the first pulselike mode of the RF source power and the second pulselike mode of the RF bias power is in a range of between 90° and 180°.

13. The method of claim 11, wherein,
the etching of the at least one portion of the MTJ layer further includes injecting a first etch gas into the etching chamber, and
the injecting of the first etch gas includes supplying one selected from a gas forming a carbonyl compound and a gas forming a sulfur compound.

14. The method of claim 11, wherein,
the etching of the at least one portion of the MTJ layer further includes injecting a first etch gas into the etching chamber, and
the injecting of the first etch gas includes supplying a gas including at least one of CO, CO2, COS, CS₂, COF₂, PF₃, and combinations thereof.

15. The method of claim 11, wherein,
the etching of the at least one portion of the MTJ layer further includes injecting a first etch gas into the etching chamber, and
the first etch gas forms negative ions in the etching chamber.

16. The method of claim 11, wherein the etching of the at least one portion of the MTJ layer includes etching the at least one portion of the MTJ layer using etching equipment based on one selected from an inductively coupled plasma (ICP), a capacitively coupled plasma (CCP), electron cyclotron resonance (ECR), reactive ion etching (RIE), magnetically enhanced RIE (MERIE), and a helicon wave.

17. A method for manufacturing a magnetic tunnel junction structure, the method comprising:
forming a magnetic tunnel junction (MTJ) layer by sequentially stacking a first ferromagnetic layer, a tunnel insulation layer, and a second ferromagnetic layer on a substrate;
forming a mask pattern on the MTJ layer; and
removing a portion of the MTJ layer to form the magnetic tunnel junction structure by subjecting the MTJ layer to ions generated from a first RF power and a second RF power having a mode out of phase with that of the first RF power.

18. The method of claim 17, wherein a phase difference between the mode of the first RF power and a mode of the second RF power is in a range of between 90° and 180°.

19. The method of claim 17, wherein removing the portion of the MTJ layer includes,
positioning the MTJ layer formed on the substrate in an etching chamber, and
intermittently applying a RF source power to a first electrode of the etching chamber as the first RF power and a RF bias power to a second electrode of the etching chamber as the second RF power to generate the ions.

20. The method of claim 19, wherein intermittently applying the RF bias power to the second electrode includes applying the RF bias power to a plasmatized gas to generate negative ions, and
the second RF power of the RF bias power has a frequency of 1 MHz or less.
